(19) United States
(12) Patent Application Publication
(10) Pub. No.: US 2023/0024417 A1
(43) Pub. Date: Jan. 26, 2023

(54) CHARGE-DISCHARGE UNIT, BATTERY MODULE, AND POWER SYSTEM

(71) Applicant: Murata Manufacturing Co., Ltd., Nagaokakyo-shi (JP)

(72) Inventors: Naoki YAMAGUCHI, Nagaokakyo-shi (JP); Kouta FURUHASHI, Nagaokakyo-shi (JP)

(21) Appl. No.: 17/958,481

(22) Filed: Oct. 3, 2022

Related U.S. Application Data
(63) Continuation of application No. PCT/JP2021/009300, filed on Mar. 9, 2021.

(30) Foreign Application Priority Data
Apr. 23, 2020 (JP) 2020-076498

(51) Int. Cl. H02J 7/00

(52) U.S. Cl. CPC H02J 7/0063; H02J 7/00714; H02J 7/0069; H02J 2207/20

(57) ABSTRACT

A charge-discharge unit includes a discharge circuit, a charge-discharge circuit, wires respectively connecting the discharge circuit and the charge-discharge circuit to a load, and a unit controller to control the discharge circuit and the charge-discharge circuit. The unit controller is configured or programmed to control the discharge circuit and the charge-discharge circuit in a first mode or a second mode. In the first mode, the discharge circuit and the charge-discharge circuit are controlled such that the discharge circuit outputs to the load a current greater than zero, and the charge-discharge circuit outputs to a battery a current greater than zero. In the second mode, the discharge circuit is controlled to output to the load a current of a value greater than zero, and the charge-discharge circuit is caused to perform a charge termination operation of stopping the current outputted to the battery.

### CROSS REFERENCE TO RELATED APPLICATIONS

This application claims the benefit of priority to Japanese Patent Application No. 2020-076498 filed on Apr. 23, 2020 and is a Continuation Application of PCT Application No. PCT/JP2021/009300 filed on Mar. 9, 2021. The entire contents of each application are hereby incorporated herein by reference.

### BACKGROUND OF THE INVENTION

### 1. Field of the Invention

The present invention relates to a charge-discharge unit, a battery module, and a power system.

### 2. Description of the Related Art

A power system including a converter unit that has a plurality of converters coupled in parallel with each other and that transforms input voltage and outputs the voltage to a load, a battery module that is coupled in parallel with the converter unit and that supplies electric power to the load, and a monitoring and control device that controls the operations of the plurality of converters based on the load current and the current output capability of the converters has been developed (refer to, for example, International Publication No. 2017/208764). The battery module includes a bidirectional DC-DC converter, a rechargeable battery, and a DC-DC converter. Based on a current sharing signal inputted from the converter unit, a controller determines the load condition. When the load is not in a high load condition, the bidirectional DC-DC converter can be controlled such that the rechargeable battery is charged with the output power of the converter unit.

### SUMMARY OF THE INVENTION

However, in the power system described in International Publication No. 2017/208764, while the rechargeable battery in the battery module is charged, if the load condition changes, the voltage outputted from the converter unit to the load may change.

Preferred embodiments of the present invention provide charge-discharge units, battery modules, and power systems in which a change in a voltage outputted to a load is reduced or prevented when a condition of the load changes.

A charge-discharge unit according to a preferred embodiment of the present invention, which is coupled between a load that is coupled to a power supply unit to convert electric power supplied from a power source and output a voltage and an electric accumulator that is coupled to the load to output a specific voltage, and is operable to control charging and discharging of the electric accumulator, includes a first power converter circuit and a second power converter circuit coupled in parallel between the load and the electric accumulator, the first power converter circuit being configured to output a current to the load, the second power converter circuit being configured to output a current to the electric accumulator, and a unit controller coupled to the first power converter circuit and the second power converter circuit and configured or programmed to control the first power converter circuit and the second power converter circuit. An output of the first power converter circuit is electrically coupled to an input of the second power converter circuit. An output of the second power converter circuit is electrically coupled to an input of the first power converter circuit. The unit controller is configured or programmed to control the first power converter circuit and the second power converter circuit in a first mode or a second mode. In the first mode, the first power converter circuit and the second power converter circuit are controlled to each output a current greater than zero. In the second mode, the first power converter circuit is controlled to output a current of a value greater than zero, and the second power converter circuit is caused to perform a charge termination operation of stopping the current outputted to the electric accumulator.

In a charge-discharge unit according to a preferred embodiment of the present invention, the unit controller may be configured or programmed to control the first power converter circuit and the second power converter circuit such that at least a portion of a current outputted from the first power converter circuit is inputted to the second power converter circuit, and at least a portion of a current outputted from the second power converter circuit is inputted to the first power converter circuit.

In a charge-discharge unit according to a preferred embodiment of the present invention, the unit controller may be configured or programmed to, when a current supplied from the power supply unit to the load is smaller than a preset upper limit current value, control the first power converter circuit and the second power converter circuit in the first mode, and the unit controller may be configured or programmed to, when the current supplied from the power supply unit to the load is more than the preset upper limit current value, control the first power converter circuit and the second power converter circuit in the second mode.

In a charge-discharge unit according to a preferred embodiment of the present invention, the unit controller may be configured or programmed to control the first power converter circuit and the second power converter circuit in the first mode when electric power is supplied from the power source and in the second mode when no electric power is supplied from the power source.

In a charge-discharge unit according to a preferred embodiment of the present invention, the first power converter circuit and the second power converter circuit may both include bidirectional DC-DC converters, and the first power converter circuit and the second power converter circuit may be configured to perform a charge operation of outputting a current to the electric accumulator and a discharge operation of outputting a current to the load, and the unit controller may be configured or programmed to, after the second power converter circuit performs the charge termination operation, control the first power converter circuit and the second power converter circuit in the second mode to perform the discharge operation.

In a charge-discharge unit according to a preferred embodiment of the present invention, the unit controller may be configured or programmed to, in the first mode, control a value of the current outputted by the first power converter circuit to the load and a value of the current outputted by the second power converter circuit to the electric accumulator, based on a record of a current value of a current supplied from the power supply unit to the load for a preset determination period including a present time point.

In a charge-discharge unit according to a preferred embodiment of the present invention, the first power converter circuit may include a non-isolated DC-DC converter including an inductor, and the unit controller may be configured or programmed to set a current value that enables a waveform of a current passed through the inductor and outputted from the first power converter circuit to the load to indicate a continuous mode.

In a charge-discharge unit according to a preferred embodiment of the present invention, the first power converter circuit and the second power converter circuit may both include bidirectional DC-DC converters, and the first power converter circuit and the second power converter circuit may be configured to perform a charge operation of outputting a current to the electric accumulator and a discharge operation of outputting a current to the load, and the unit controller may be configured or programmed to control the first power converter circuit and the second power converter circuit in a third mode or a fourth mode. In the third mode, the first power converter circuit and the second power converter circuit are controlled such that the second power converter circuit outputs to the load a discharge power greater than zero, and the first power converter circuit outputs to the electric accumulator a current greater than zero. In the fourth mode, the second power converter circuit is controlled to output to the load a current of a value greater than zero, and the first power converter circuit is caused to perform a charge termination operation of stopping the current outputted to the electric accumulator.

In another aspect, a battery module according to a preferred embodiment of the present invention, which is coupled to a power supply unit configured to convert electric power supplied from a power source and output a voltage, and is configured to supply electric power to the load, includes the charge-discharge unit, and an electric accumulator coupled to the charge-discharge unit.

In a further aspect, a power system according to a preferred embodiment of the present invention includes a power supply unit configured to convert electric power supplied from a power source and output a voltage, and the battery module coupled to the power supply unit.

In a preferred embodiment of the present invention, a unit controller is configured or programmed to control the first power converter circuit and the second power converter circuit in a first mode or a second mode. In the first mode, the first power converter circuit and the second power converter circuit are controlled to each output a current greater than zero. In the second mode, the first power converter circuit is controlled to output a current of a value greater than zero, and the second power converter circuit is caused to perform a charge termination operation of stopping the current outputted to the electric accumulator. With this configuration, either the current flowing from the power supply unit to the electric accumulator or the current flowing from the first power converter circuit to the load can be changed depending on the condition of the load, and as a result, a change in the voltage outputted to the load is reduced or prevented when the condition of the load changes.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram of a power system according to a first preferred embodiment of the present invention.

FIG. 2A is a circuit diagram of a charge circuit according to the first preferred embodiment of the present invention.

FIG. 2B illustrates an operation of the charge circuit according to the first preferred embodiment of the present invention.

FIG. 3 is a functional block diagram of a unit controller according to the first preferred embodiment of the present invention.

FIG. 4 illustrates an example of information stored in a charge-discharge control information storage section according to the first preferred embodiment of the present invention.

FIG. 5 is a flowchart illustrating an example of a flow of a charge-discharge control process performed by the unit controller according to the first preferred embodiment of the present invention.

FIG. 6A illustrates an operation of a battery module according to the first preferred embodiment of the present invention in the case in which the current value of the current supplied from a power supply unit to a load is equal to or greater than a preset upper limit current value.

FIG. 6B illustrates an operation of the battery module according to the first preferred embodiment of the present invention in the case in which the current value of the current supplied from the power supply unit to the load is smaller than the upper limit current value.

FIG. 7 is a functional block diagram of a unit controller according to a second preferred embodiment of the present invention.

FIG. 8A illustrates an example of information stored in a target current value candidate storage section according to the second preferred embodiment of the present invention.

FIG. 8B illustrates an operation of a charge circuit according to the second preferred embodiment of the present invention.

FIG. 9 is a flowchart illustrating an example of a flow of a discharge target current value update process performed by the unit controller according to the second preferred embodiment of the present invention.

FIG. 10 is a functional block diagram of a unit controller according to a third preferred embodiment of the present invention.

FIG. 11 illustrates an example of information stored in a target current value candidate storage section according to the third preferred embodiment of the present invention.

FIG. 12 is a flowchart illustrating an example of a flow of a discharge target current value update process performed by the unit controller according to the third preferred embodiment of the present invention.

FIG. 13 is a block diagram of a power system according to a modification of a preferred embodiment of the present invention.

FIG. 14 is a block diagram of a power system according to a modification of a preferred embodiment of the present invention.

FIG. 15 is a functional block diagram of a unit controller according to a modification of a preferred embodiment of the present invention.

FIG. 16 illustrates an example of information stored in a charge-discharge control information storage section according to a modification of a preferred embodiment of the present invention.

### DETAILED DESCRIPTION OF THE PREFERRED EMBODIMENTS

### First Preferred Embodiment

Hereinafter, preferred embodiments of the present invention will be described in detail with reference to the drawings. A charge-discharge unit according to the present preferred embodiment is coupled to an output end of a power supply unit to output a specific preset voltage to a load, and the charge-discharge unit controls charging and discharging of an electric accumulator. The charge-discharge unit includes a first power converter circuit to discharge electricity accumulated in the electric accumulator to the load, a second power converter circuit to receive electric power supplied from the power supply unit and charging the electric accumulator, and a unit controller to control the first power converter circuit and the second power converter circuit to maintain a first output current of the first power converter circuit at a specific value and to change the target current value of a second output current of the second power converter circuit depending on the condition of the load.

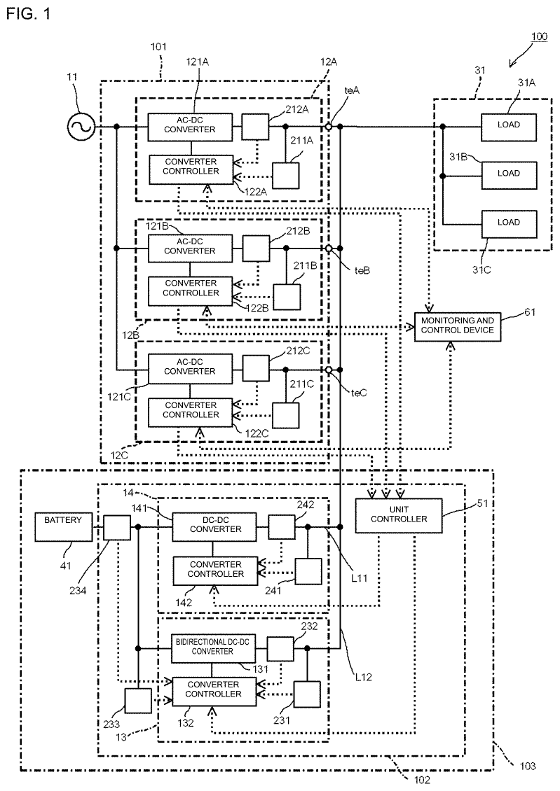

A power system according to the present preferred embodiment is usable to supply electric power to, for example, a server in which power consumption may largely change depending on the processing condition. For example, as illustrated in FIG. 1, a power system 100 according to the present preferred embodiment includes a power supply unit 101, a battery module 103, and a monitoring and control device 61. The power supply unit 101 and the battery module 103 are coupled to a load 31. Electric power is supplied from the power supply unit 101 and the battery module 103 to the load 31. The load 31 may include, for example, a plurality (for example, three in FIG. 1) of loads, namely loads 31A, 31B, and 31C, configured to operate at a specific preset voltage and coupled in parallel with each other. The loads 31A, 31B, and 31C may be, for example, blade servers, which are fitted in an enclosure in a detachable manner. Power consumption of each load may suddenly and largely change depending on the processing condition.

The power supply unit 101 includes a plurality (three in FIG. 1) of converter sections 12A, 12B, and 12C. The converter sections 12A, 12B, and 12C respectively include AC-DC converters 121A, 121B, and 121C, and converter controllers 122A, 122B, and 122C to control the operations of the AC-DC converters 121A, 121B, and 121C. The converter sections 12A, 12B, and 12C output a specific preset voltage to the load 31. The voltage outputted to the load 31 is set in accordance with the rated input voltage of the load 31 to, for example, 12 V. The AC-DC converters 121A, 121B, and 121C are coupled in parallel with each other between a system power source 11 and the load 31. The AC-DC converters 121A, 121B, and 121C each include a transformer, a rectifier and smoothing circuit, and a power converter circuit that includes a switching element and that steps up or steps down voltage. The converter sections 12A, 12B, and 12C respectively include voltage detectors 211A, 211B, and 211C to detect the output voltage from the AC-DC converters 121A, 121B, and 121C and current detectors 212A, 212B, and 212C to detect the output current from the AC-DC converters 121A, 121B, and 121C.

The converter controllers 122A, 122B, and 122C may be, for example, microcomputers including internal clocks, respectively corresponding to the AC-DC converters 121A, 121B, and 121C. The converter controllers 122A, 122B, and 122C provide constant voltage control for the AC-DC converters 121A, 121B, and 121C by controlling the operation of the switching element of the power converter circuit in the AC-DC converters 121A, 121B, and 121C. As a result, the AC-DC converters 121A, 121B, and 121C each convert an alternating current (for example, 200 V) supplied by the system power source 11 into a direct-current voltage (for example, 12 V) by transforming, rectifying and smoothing, and then stepping down the alternating current and supply the direct-current voltage to the load 31. The converter controllers 122A, 122B, and 122C also have a so-called current sharing function, in which the converter controllers 122A, 122B, and 122C individually provide control based on output currents from the AC-DC converters 121A, 121B, and 121C controlled by the others of the converter controllers 122A, 122B, and 122C so that the current values of the output currents from the AC-DC converters 121A, 121B, and 121C are balanced. The converter controllers 122A, 122B, and 122C individually output to the monitoring and control device 61 a current sharing signal containing information indicating a current value of the output current from a corresponding control target of the AC-DC converters 121A, 121B, and 121C. The converter controllers 122A, 122B, and 122C activate or deactivate the AC-DC converters 121A, 121B, and 121C based on instruction information inputted from the monitoring and control device 61.

The current detectors 212A, 212B, and 212C detect a current value of the output current from the respective AC-DC converters 121A, 121B, and 121C by, for example, detecting a voltage between two ends of a resistor (not illustrated in the drawing) coupled in series between the AC-DC converters 121A, 121B, and 121C and the load 31. The voltage detectors 211A, 211B, and 211C respectively output to the converter controllers 122A, 122B, and 122C a voltage proportional to the detected output current. The voltage detectors 211A, 211B, and 211C detect, for example, the voltage difference between a voltage obtained by dividing the voltage at respective output ends teA, teB, and teC of the power supply unit 101 by a given voltage division ratio and a reference voltage that is preset in accordance with the specifications of the load 31. The voltage detectors 211A, 211B, and 211C output a voltage corresponding to the detected voltage difference to the converter controllers 122A, 122B, and 122C. Based on the voltage difference inputted by the voltage detectors 211A, 211B, and 211C, the converter controllers 122A, 122B, and 122C control the operations of the AC-DC converters 121A, 121B, and 121C to constantly output a specific voltage corresponding to the reference voltage.

The monitoring and control device 61 determines the condition of the load 31 in accordance with the information indicating the current value of the output current included in the current sharing signal inputted by the individual converter controllers 122A, 122B, and 122C. Because the output current from the AC-DC converters 121A, 121B, and 121C is usually maintained to be constant, the monitoring and control device 61 can specify the current value of the current flowing into the load 31 in accordance with the information indicating the current value of the output current included in the current sharing signal and accordingly determine the condition of the load 31. When the load 31 is in a low load condition, the monitoring and control device 61 outputs instruction information to stop the operation of any of the AC-DC converters 121A, 121B, and 121C to the converter controllers 122A, 122B, and 122C. When the load 31 is in the light load condition, a relatively small amount of current flows into the load 31. Thus, by stopping any of the AC-DC converters 121A, 121B, and 121C, the other operating AC-DC converters of the AC-DC converters 121A, 121B, and 121C can operate with higher power conversion efficiency.

The battery module 103 includes a battery 41 and a charge-discharge unit 102 that is coupled to the output ends teA, teB, and teC of the power supply unit 101 and that controls charging and discharging of the battery 41. The battery 41 is an electric accumulator that is coupled to the output ends teA, teB, and teC of the power supply unit 101 and that outputs a specific voltage to the load 31. The battery 41 may be, for example, a lithium-ion battery or redox flow battery. The battery 41 outputs a direct-current voltage of, for example, about 35 V to about 59 V.

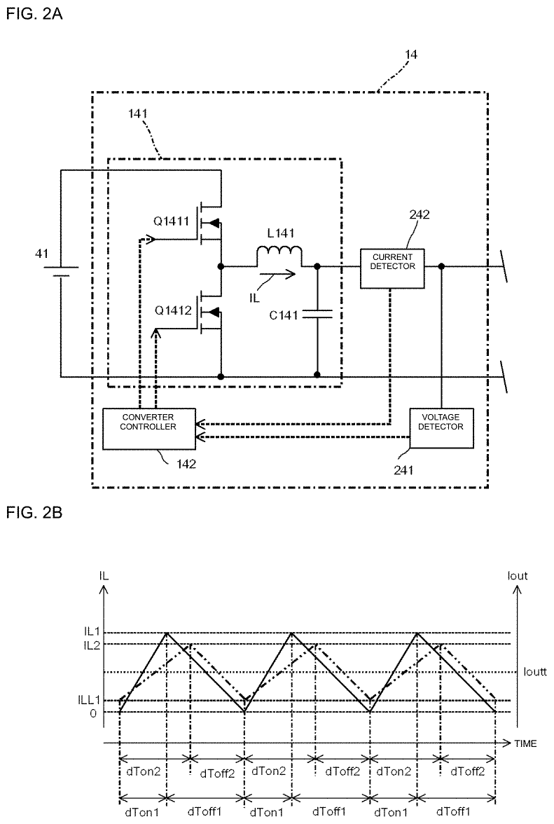

The charge-discharge unit 102 is coupled between the output ends teA, teB, and teC of the power supply unit 101 and the battery 41 and controls the current flowing between the battery 41 and the load 31. The charge-discharge unit 102 includes a charge-discharge circuit 13, a discharge circuit 14, the battery 41, a current detector 234, a voltage detector 233, a unit controller 51, and wires L11 and L12 that are coupled to the load 31 and to the discharge circuit 14 or the charge-discharge circuit 13. The discharge circuit 14 is a first power converter circuit to discharge electricity accumulated in the battery 41 to the load 31. The discharge circuit 14 includes a DC-DC converter 141, the converter controllers 142 to control the operation of the DC-DC converter 141, a current detector 242, and a voltage detector 241. The DC-DC converter 141 is a non-isolated DC-DC converter to step down voltage, for example, as illustrated in FIG. 2A. The DC-DC converter 141 includes two switching elements Q1411 and Q1412 coupled between the output ends of the battery 41 and also includes an inductor L141 and a capacitor C141. The switching elements Q1411 and Q1412 may be, for example, N-channel metal-oxide-semiconductor field-effect transistors (MOSFETs). The source of the switching element Q1411 is coupled to the drain of the switching element Q1412. One end of the inductor L141 is coupled by common connection to the source of the switching element Q1411 and the drain of the switching element Q1412. The capacitor C141 is coupled between the other end of the inductor L141 and the source of the switching element Q1412. The voltage between the two ends of the capacitor C141 is outputted to the load 31. A converter controller 142 provides pulse width modulation (PWM) control for the DC-DC converter 141.

The current detector 242 detects the current value of the output current from the DC-DC converter 141 by, for example, detecting a voltage between two ends of a resistor (not illustrated in the drawing) coupled in series between the DC-DC converter 141 and the load 31. The current detector 242 outputs a voltage proportional to the detected output current to the converter controller 142. Based on the voltage inputted by the current detector 242, the converter controller 142 controls the DC-DC converter 141 such that the current value of the output current from the DC-DC converter 141 reaches a target current value corresponding to an instruction signal inputted by the unit controller 51. This target current value is set to a value that enables the waveform of a current IL flowing in the inductor L141 to indicate the continuous mode as illustrated in FIG. 2B. In FIG. 2B, periods dTon1 and dTon2 indicate a period for which the switching element Q1411 is ON while the switching element Q1412 is OFF. Periods dToff1 and dToff2 indicate a period for which the switching element Q1411 is OFF while the switching element Q1412 is ON. When the SOC value of the battery 41 decreases, and the output voltage from the battery 41 accordingly lowers, the converter controller 142 changes the duty ratio from dTon1/(dTon1+dToff1) to dTon2/dTon2+dToff2 to maintain the output current at a current value Ioutt. The L value of the inductor L141 is set to a value that enables the waveform of the current IL to be maintained in the continuous mode by changing the duty ratio when the output voltage from the battery 41 changes as described above. Referring back to FIG. 1, the voltage detector 241 detects, for example, the voltage difference between a voltage obtained by dividing the voltage at the respective output ends teA, teB, and teC of the power supply unit 101 by a given voltage division ratio and a reference voltage that is preset in accordance with the specifications of the load 31. The voltage detector 241 outputs a voltage corresponding to the detected voltage difference to the converter controller 142. Based on the voltage difference inputted by the voltage detector 241, the converter controller 142 controls the operation of the DC-DC converter 141 to constantly output a specific voltage corresponding to the reference voltage. The current detector 242 detects the current flowing through the wire L11 connected to the load 31, the DC-DC converter 141, and a bidirectional DC-DC converter 131.

The charge-discharge circuit 13 is a second power converter circuit that operates in an operation mode of a charge mode or a discharge mode. In the charge mode, the charge-discharge circuit 13 receives electric power supplied from the power supply unit 101 and charges the battery 41. In the discharge mode, the charge-discharge circuit 13 discharges electricity accumulated in the battery 41 to the load 31. The charge-discharge circuit 13 includes the bidirectional DC-DC converter 131, a converter controller 132 to control the operation of the bidirectional DC-DC converter 131, a current detector 232, and a voltage detector 231. The bidirectional DC-DC converter 131 includes a switching element and steps up or steps down voltage. The converter controller 132 may be, for example, a microcomputer including an internal clock. The converter controller 132 provides constant voltage control or constant current control for the bidirectional DC-DC converter 131 by controlling the operation of the switching element of the bidirectional DC-DC converter 131. The converter controller 132 controls the bidirectional DC-DC converter 131 by PWM control. In the charge mode, the converter controller 132 switches between constant current control and constant voltage control in accordance with the state of charge (SOC) value of the battery 41. By reference to the output voltage of the battery 41 detected by the voltage detector 233, when the output voltage is equal to or lower than a voltage corresponding to a preset SOC threshold (for example, 90%), the converter controller 132 provides constant current control for the bidirectional DC-DC converter. In contrast, when the output voltage of the battery 41 exceeds the voltage corresponding to the SOC threshold, the converter controller 132 provides constant voltage control for the bidirectional DC-DC converter.

The current detector 232 detects the current value of the output current or input current of the bidirectional DC-DC converter 131 by, for example, detecting a voltage between two ends of a resistor (not illustrated in the drawing) coupled in series between the bidirectional DC-DC converter 131 and the load 31. The current detector 232 outputs a voltage proportional to the detected output current to the converter controller 132. When the converter controller 132 causes the bidirectional DC-DC converter 131 to operate in the discharge mode, the converter controller 132 can control, based on the voltage inputted by the current detector 232, the bidirectional DC-DC converter 131 to maintain the output current at a specific value. The voltage detector 231 detects, for example, the voltage difference between a voltage obtained by dividing the voltage at the respective output ends teA, teB, and teC of the power supply unit 101 by a given voltage division ratio and a reference voltage that is preset in accordance with the specifications of the load 31. The voltage detector 231 outputs a voltage corresponding to the detected voltage difference to the converter controller 132. When the converter controller 132 causes the bidirectional DC-DC converter 131 to operate in the discharge mode, the converter controller 132 controls, based on the voltage difference inputted by the voltage detector 231, the operation of the bidirectional DC-DC converter 131 to constantly output a current voltage corresponding to the reference voltage. The current detector 232 detects the current flowing through the wire L12 connected to the load 31, the DC-DC converter 141, and the bidirectional DC-DC converter 131.

The current detector 234 detects the current value of the output current from the bidirectional DC-DC converter 131 by, for example, detecting a voltage between two ends of a resistor (not illustrated in the drawing) coupled in series between the battery 41, and the discharge circuit 14 and the charge-discharge circuit 13. The current detector 232 outputs a voltage proportional to the detected output current to the converter controller 132. The voltage detector 233 detects, for example, a voltage between the output ends of the battery 41. The voltage detector 233 outputs the detected voltage to the converter controller 132. In the case in which the converter controller 132 causes the bidirectional DC-DC converter 131 to operate in the charge mode, when the voltage detected by the voltage detector 233 is equal to or lower than the voltage corresponding to the SOC threshold of the battery 41, the converter controller 132 controls, based on the voltage inputted by the current detector 234, the bidirectional DC-DC converter 131 to operate such that the current value of the output current of the bidirectional DC-DC converter 131 reaches a target current value corresponding to an instruction signal inputted by the unit controller 51. In contrast, when the voltage detected by the voltage detector 233 exceeds the voltage corresponding to the SOC threshold of the battery 41, the converter controller 132 controls, based on the voltage inputted by the voltage detector 233, the bidirectional DC-DC converter 131 to output a specific voltage.

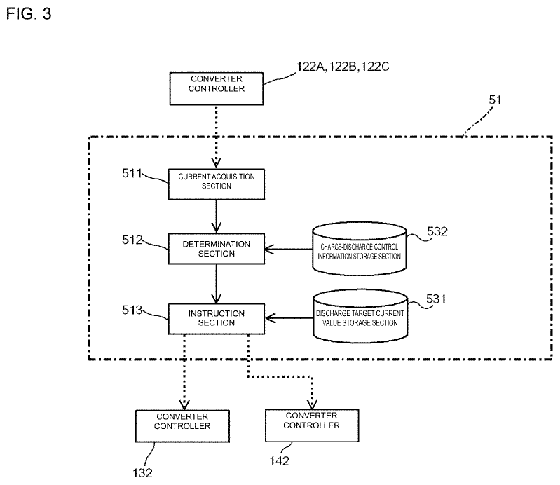

When the charge-discharge circuit 13 operates in the charge mode, the unit controller 51 controls the discharge circuit and the charge-discharge circuit 13 to maintain a specific output current of the discharge circuit 14 and to change a target current value of output current of the charge-discharge circuit 13 depending on the condition of the load 31. The unit controller 51 includes a processor and a memory. The processor runs a program stored in the memory, so that the unit controller 51 functions as a current acquisition section 511, a determination section 512, and an instruction section 513 as illustrated in FIG. 3. The memory includes a discharge target current value storage section 531 to store target current value information indicating a target current value of the output current of the discharge circuit 14 and a charge-discharge control information storage section 532.

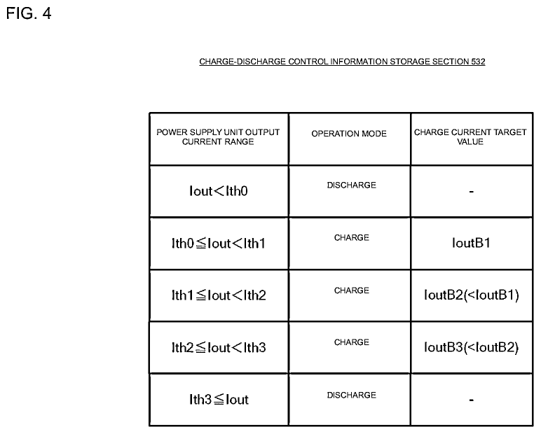

The charge-discharge control information storage section 532 stores, for example, as indicated in FIG. 4, operation mode information indicating the operation mode of the charge-discharge circuit 13 and target current value information indicating a target current value of output current of the charge-discharge circuit 13 when the charge-discharge circuit 13 operates in the charge mode, in association with information indicating an output current range of the converter sections 12A, 12B, and 12C. In the example indicated in FIG. 4, when a current value Iout of the current supplied by the converter sections 12A, 12B, and 12C to the load 31 is equal to or greater than a preset upper limit current value Ith3 or smaller than a lower limit current value Ith0, the charge-discharge circuit 13 is set to operate in the discharge mode. When the current value Iout is smaller than the upper limit current value Ith3, the charge-discharge circuit 13 is set to operate in the charge mode. Here, the lower limit current value Ith0 is a threshold to detect the condition in which the power supply unit 101 stops operating and do not output current. The lower limit current value Ith0 is set to a value close to zero that can determine that the power supply unit 101 stops operating. In the case in which the charge-discharge circuit 13 is caused to operate in the charge mode, when the current value Iout is equal to or greater than the lower limit current value Ith0 and smaller than a current threshold Ith1, the target value of output current of the charge-discharge circuit 13 is set to a current value IoutB1. When the current value Iout is equal to or greater than a current threshold Ith2 and smaller than the current threshold Ith1, the target value of output current of the charge-discharge circuit 13 is set to a current value IoutB2 smaller than IoutB1. When the current value Iout is equal to or greater than the current threshold Ith2 and smaller than the upper limit current value Ith3, the target value of output current of the charge-discharge circuit 13 is set to a current value IoutB3 smaller than the current value IoutB2. In other words, when the charge-discharge circuit 13 is caused to operate in the charge mode, the target current value of output current of the charge-discharge circuit 13 is set such that, the more current the converter sections 12A, 12B, and 12C output, the smaller value the target current value of output current of the charge-discharge circuit 13 is set to. When the charge-discharge circuit 13 changes from the charge mode to the discharge mode, instead of changing directly from the charge mode to the discharge mode, the charge-discharge circuit 13 changes, for example, from the charge mode to a charge termination operation and to the discharge mode. Thus, the charge-discharge circuit 13 performs an operation of deactivating the circuit before changing the mode. When the charge-discharge circuit 13 changes from the discharge mode to the charge mode, the charge-discharge circuit 13 similarly changes, for example, from the discharge mode to the termination operation and to the charge mode.

The unit controller 51 controls the charge-discharge circuit 13 and the discharge circuit 14 by control of a first mode or control of a second mode. Under the control of the first mode, the current detector 242 detects a value greater than zero as the current flowing in the direction from the DC-DC converter 141 to the wire L11, and the current detector 232 detects a value greater than zero as the current flowing in the direction from the wire L12 to the bidirectional DC-DC converter 131. In the present preferred embodiment, in the condition in which Iout<Ith3, the control of the first mode is provided.

Under the control of the second mode, the current detector 242 detects a value greater than zero as the current flowing in the direction from the DC-DC converter 141 to the wire L11, and the charge termination operation is performed to terminate charging with the bidirectional DC-DC converter 131. In this practical example, in the condition in which Iout≥Ith3, the control of the second mode is provided. By stopping charging of the battery, the current discharged from the DC-DC converter 141 is all supplied to the load. As described above, when the current supplied from the power supply unit 101 suffices to supply load current, the charge-discharge unit is controlled in the first mode. When the current supplied from the power supply unit 101 becomes insufficient, the first mode is changed to the second mode to control the charge-discharge unit. As a result, current is speedily supplied to the load while a change in load voltage is reduced or prevented.

The condition for the control of the first mode and the condition for the control of the second mode are not limited to the conditions described above. The first mode and the second mode may be switched depending on the condition of the system power source 11. For example, the power supply unit 101 monitors whether electric power is supplied from the system power source 11 and informs the unit controller 51 of the charge-discharge unit 102. When electric power is supplied from the system power source 11, the unit controller 51 provides control in the first mode. When no electric power is supplied from the system power source 11, the unit controller 51 provides control in the second mode. With the control described above, when the system power source 11 is cut off, current is speedily supplied to the load while a change in load voltage is reduced or prevented. The condition in which no electric power is supplied from the system power source 11 is determined by detection, for example, when the input voltage to the AC-DC converters 121A, 121B, and 121C is equal to or lower than a predetermined value or when the output voltage from the AC-DC converters 121A, 121B, and 121C is equal to or lower than a predetermined value.

Under the control of the second mode by the unit controller 51, the charge-discharge circuit 13 may be changed from the discharge mode to a discharge termination operation of stopping discharging and then controlled to perform a discharge operation. By causing the charge-discharge circuit 13 to perform the discharge operation, an increased amount of current can be supplied to the load, thus further reducing or preventing a change in load voltage.

Referring back to FIG. 3, the current acquisition section 511 acquires current value information indicating a current value of output current of the individual AC-DC converters 121A, 121B, and 121C included in the current sharing signal outputted from the individual converter sections 12A, 12B, and 12C. The current acquisition section 511 informs the determination section 512 of the acquired current value information. The determination section 512 refers to the information stored in the charge-discharge control information storage section 532 and determines the operation mode of the charge-discharge circuit 13 and the target current value of output current in the charge mode, based on the current value of output current indicated by the information provided by the current acquisition section 511. Here, when the current value Iout, which is supplied from the converter sections 12A, 12B, and 12C to the load 31, is equal to or greater than the upper limit current value Ith3, the determination section 512 selects the discharge mode. When the current value Iout is smaller than the upper limit current value Ith3, the determination section 512 selects the charge mode.

The instruction section 513 outputs to the converter controller 132 of the charge-discharge circuit 13 operation mode information indicating an operation mode determined by the determination section 512 and target current value information indicating a target current value of output current in the charge mode. The instruction section 513 also acquires discharge target current value information stored in the discharge target current value storage section 531 and outputs the discharge target current value information to the converter controller 142 of the discharge circuit 14.

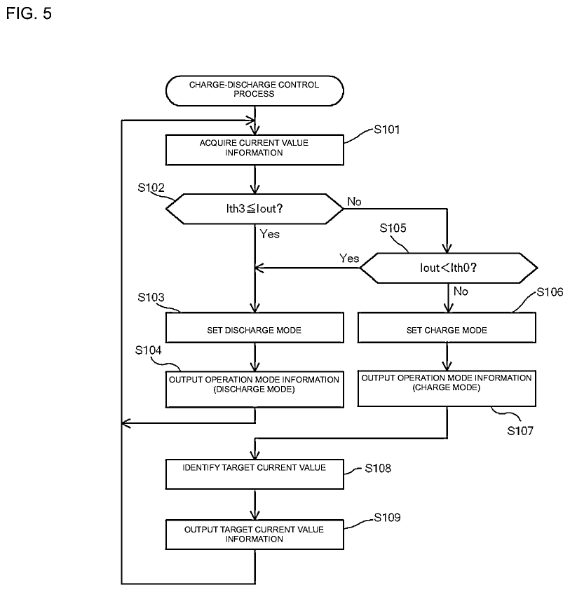

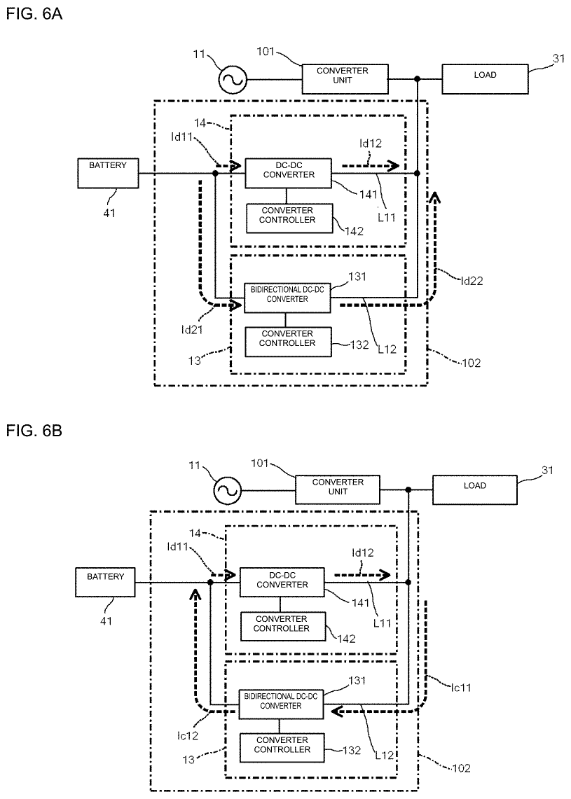

The following describes a charge-discharge control process performed by the unit controller according to the present preferred embodiment with reference to FIGS. 5 and 6. Firstly, the current acquisition section 511 acquires current value information of the AC-DC converters 121A, 121B, and 121C from the respective converter sections 12A, 12B, and 12C (step S101). Next, the determination section 512 refers to the information stored in the charge-discharge control information storage section 532 and determines whether the current value Iout, which is indicated by the current value information provided by the current acquisition section 511, is equal to or greater than the upper limit current value Ith3 (step S102). Here, it is assumed that the determination section 512 determines the current value Iout is equal to or greater than the upper limit current value Ith3 (Yes in step S102). In this case, the operation mode of the charge-discharge circuit 13 is determined to be the discharge mode (step S103), and the instruction section 513 outputs to the converter controller 132 operation mode information indicating the discharge mode determined by the determination section 512 (step S104). In this case, as illustrated in FIG. 6A, the charge-discharge circuit 13 operates in the discharge mode. In the discharge mode, a discharge current Id11 flows from the battery 41 to the discharge circuit 14, and also, a discharge current Id21 flows from the battery 41 to the charge-discharge circuit 13. As a result, both the discharge circuit 14 and the charge-discharge circuit 13 supply currents Id12 and Id22 to the load 31. Referring back to FIG. 5, subsequently, the operation in step S101 is repeated.

Conversely, it is assumed that the determination section 512 determines the current value Iout is smaller than the upper limit current value Ith3 (No in step S102). In this case, the determination section 512 refers to the information stored in the charge-discharge control information storage section 532 and determines whether the current value Iout, which is indicated by the current value information provided by the current acquisition section 511, is smaller than the lower limit current value Ith0 (step S105). When the determination section 512 determines that the current value Iout is smaller than the lower limit current value Ith0 (Yes in step S105), the operations in step S103 and the subsequent step are performed. By contrast, it is assumed that the determination section 512 determines the current value Iout is equal to or greater than the lower limit current value Ith0 (No in step S105). In this case, the determination section 512 determines the operation mode of the charge-discharge circuit 13 to be the charge mode (step S106), and the instruction section 513 outputs to the converter controller 132 operation mode information indicating the charge mode determined by the determination section 512 (step S107). In this case, as illustrated in FIG. 6B, the charge-discharge circuit 13 operates in the charge mode; in the charge mode, a charge current Ic12 flows from the charge-discharge circuit 13 to the battery 41. Also, the battery 41 and the charge-discharge circuit 13 supply a current Id11 to the discharge circuit 14. The discharge circuit 14 supplies the current Id12 to the load 31, while the power supply unit 101 supplies a current Ic11 to the charge-discharge circuit 13.

Referring back to FIG. 5, subsequently, the determination section 512 refers to the information stored in the charge-discharge control information storage section 532 and identifies a target current value corresponding to the current value Iout indicated by the current value information (step S108). When the current value Iout is smaller than the current threshold Ith1, the determination section 512 identifies the target current value IoutB1. When the current value Iout is equal to or greater than the current threshold Ith2 and smaller than the current threshold Ith1, the determination section 512 identifies the target current value IoutB2. When the current value Iout is equal to or greater than the current threshold Ith2 and smaller than the current threshold Ith3, the determination section 512 identifies the target current value IoutB3. Next, the instruction section 513 outputs to the converter controller 132 target current value information indicating a target current value identified by the determination section 512 (step S109). Subsequently, the operation in step S101 is repeated.

As described above, with the battery module 103 according to the present preferred embodiment, when the current supplied from the power supply unit 101 to the load 31 is smaller than the preset upper limit current value Ith3, the unit controller 51 controls the discharge circuit 14 to maintain the output current at a specific value, while the unit controller 51 changes the target current value of the charge-discharge circuit 13, so that the unit controller 51 controls the discharge circuit 14 and the charge-discharge circuit 13 to maintain the condition in which current flows in the wires L11 and L12, the discharge circuit 14, and the charge-discharge circuit 13. By contrast, when the current supplied from the power supply unit 101 to the load 31 is equal to or greater than the upper limit current value Ith3, the unit controller 51 controls the charge-discharge circuit 13 to perform the charge termination operation of stopping the charge-discharge circuit 13 outputting current toward the battery 41, that is, an operation of discharging the battery 41. This configuration can change the current flowing from the power supply unit 101 to the battery 41 depending on the condition of the load 31, and thus, it is possible to reduce or prevent a change in the voltage outputted to the load 31 when the condition of the load 31 changes.

The charge-discharge circuit 13 according to the present preferred embodiment operates in an operation mode of the charge mode or the discharge mode. In the charge mode, the charge-discharge circuit 13 receives electric power supplied from the power supply unit 101 and charges the battery 41. In the discharge mode, the charge-discharge circuit 13 discharges electricity accumulated in the battery 41 to the load 31. When the current value of output current of the converter sections 12A, 12B, and 12C is equal to or greater than the upper limit current value Ith3, the unit controller 51 causes the charge-discharge circuit 13 to operate in the discharge mode. By contrast, when the current value of output current of the converter sections 12A, 12B, and 12C is smaller than the upper limit current value Ith3, the unit controller 51 causes the charge-discharge circuit 13 to operate in the charge mode. With this configuration, for example, when the condition of the load 31 is as high load as a drop in the voltage outputted to the load 31 cannot be prevented by only the current supplied from the discharge circuit 14 to the load 31, sufficient current to prevent a drop in the voltage outputted to the load 31 is supplied from the discharge circuit 14 and the charge-discharge circuit 13 to the load 31. Thus, when the condition of the load 31 largely changes, it is possible to reduce or prevent a change in the voltage outputted to the load 31.

Further, the unit controller 51 according to the present preferred embodiment sets the target current value of output current of the discharge circuit 14 to a current value that enables the waveform of the current IL flowing in the inductor L141 to indicate the continuous mode. With this configuration, current is stably supplied from the discharge circuit 14 to the load 31, and thus, it is possible to reduce or prevent a change in the voltage outputted to the load 31.

Furthermore, when the charge-discharge circuit 13 operates in the charge mode, the unit controller 51 according to the present preferred embodiment controls the discharge circuit 14 and the charge-discharge circuit 13 to maintain the output current of the discharge circuit 14 at a specific value and to change a target current value of output current of the charge-discharge circuit 13 depending on the condition of the load 31. With this configuration, current is efficiently supplied from the battery 41 to the load 31, and thus, it is possible to reduce or prevent a change in the voltage outputted to the load 31.

### Second Preferred Embodiment

A power system according to the present preferred embodiment differs from the first preferred embodiment in that a unit controller changes the target current value of output current of a discharge circuit in accordance with SOC of the battery 41. The unit controller sets the target current value of output current of the discharge circuit 14 to a current value that enables the waveform of the current flowing in an inductor of the discharge circuit to indicate the continuous mode.

The configuration of the power system according to the present preferred embodiment is almost the same as the configuration of the power system according to the first preferred embodiment, but only the functional configuration of the unit controller is different. In the description of the present preferred embodiment, the same configurations as the first preferred embodiment are described with the same reference characters as in FIGS. 1 and 2.

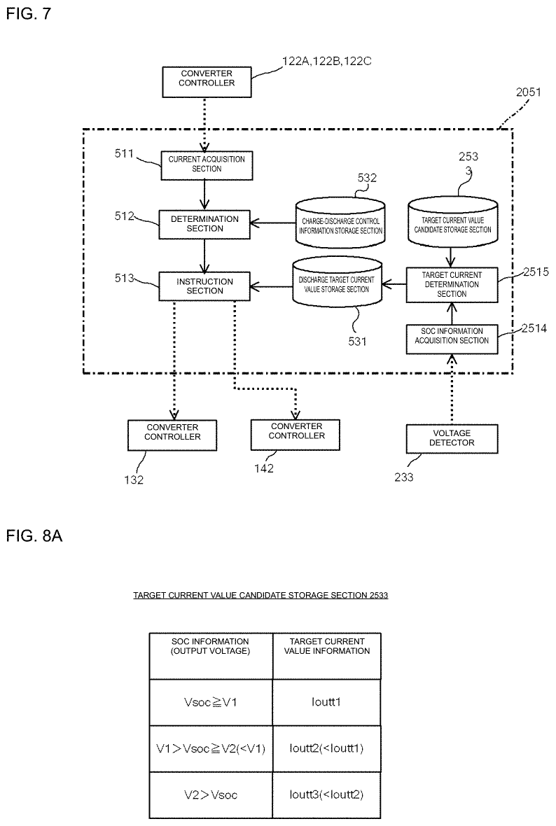

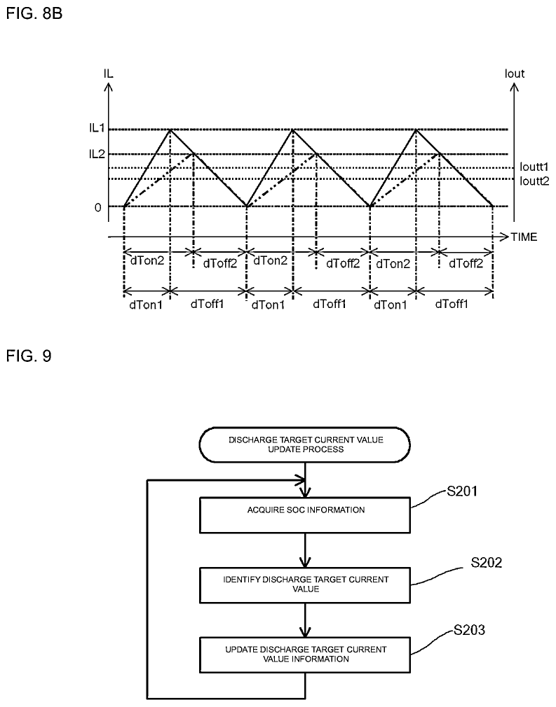

As illustrated in FIG. 7, a unit controller 2051 has the same hardware configuration as the unit controller 51 described in the first preferred embodiment and functions as the current acquisition section 511, the determination section 512, the instruction section 513, a SOC information acquisition section 2514, and a target current determination section 2515. In FIG. 7, the same configurations as the first preferred embodiment are denoted by the same reference characters as in FIG. 3. The memory includes the discharge target current value storage section 531, the charge-discharge control information storage section 532, and a target current value candidate storage section 2533. The target current value candidate storage section 2533 stores, for example, as indicated in FIG. 8A, target current value information of the discharge circuit 14 in association with SOC information indicating corresponding output voltages of the battery 41. In the example indicated in FIG. 8A, when an output voltage Vsoc of the battery 41 is equal to or higher than a preset voltage threshold V1, the target current value of output current of the discharge circuit 14 is set to a current value Ioutt1. When the output voltage Vsoc of the battery 41 is equal to or higher than a voltage threshold V2, which is smaller than the voltage threshold V1, and lower than the voltage threshold V1, the target current value of output current of the discharge circuit 14 is set to a current value Ioutt2 smaller than the current value Ioutt1. When the output voltage Vsoc of the battery 41 is equal to or higher than a voltage threshold V1, which is smaller than the voltage threshold V2, and lower than the voltage threshold V2, the target current value of output current of the discharge circuit 14 is set to a current value Iott3 smaller than the current value Ioutt2. When the output voltage Vsoc of the battery 41 is lower than the voltage threshold V3, the target current value of output current of the discharge circuit 14 is set to a current value Ioutt4 smaller than the current value Ioutt3. In other words, the lower the output voltage of the battery 41 is, the smaller value the target current value of output current of the discharge circuit 14 is set to.

The target current value is set to a value that enables the waveform of the current IL flowing in the inductor L141 illustrated in FIGS. 2A and 2B to indicate the continuous mode as illustrated in FIG. 8B. In FIG. 8B, the periods dTon1 and dTon2 indicate a period for which the switching element Q1411 is ON while the switching element Q1412 is OFF; the periods dToff1 and dToff2 indicate a period for which the switching element Q1411 is OFF while the switching element Q1412 is ON.

Referring back to FIG. 7, the SOC information acquisition section 2514 acquires information indicating a voltage value of output voltage of the battery 41 detected by the voltage detector 233 as SOC information and informs the target current determination section 2515 of the acquired SOC information. The target current determination section 2515 refers to the information stored in the target current value candidate storage section 2533, identifies a target current value corresponding to the voltage value indicated by the SOC information acquired by the SOC information acquisition section 2514, and stores the identified target current value in the discharge target current value storage section 531. As illustrated in FIG. 8B, when the SOC value of the battery 41 decreases, and the output voltage of the battery 41 lowers, the target current determination section 2515 changes the target current value Tout of output current of the discharge circuit 14 from the current value Ioutt1 to the current value Ioutt2 smaller than the current value Ioutt1. At this time, the converter controller 142 changes the duty ratio from dTon1/(dTon1+dToff1) to dTon2/dTon2+dToff2 to maintain the output current at the current value Ioutt2 after change.

The following describes a discharge target current value update process performed by the unit controller according to the present preferred embodiment with reference to FIG. 9. Firstly, the SOC information acquisition section 2514 acquires information indicating a voltage value detected by the voltage detector 233 as SOC information (step S201). At this time, the SOC information acquisition section 2514 informs the target current determination section 2515 of the acquired SOC information. Next, the target current determination section 2515 refers to the information stored in the target current value candidate storage section 2533 and identifies a discharge target current value of the discharge circuit 14 in accordance with a voltage value Vsoc indicated by the SOC information provided by the SOC information acquisition section 2514 (step S202). Here, when the voltage value Vsoc is equal to or greater than the voltage threshold V1, the target current determination section 2515 identifies the current value Ioutt1 as the discharge target current value. When the voltage value Vsoc is equal to or greater than the voltage threshold V2 and smaller than the voltage threshold V1, the target current determination section 2515 identifies the current value Ioutt2 smaller than the current value Ioutt1 as the discharge target current value. When the voltage value Vsoc is smaller than the voltage threshold V2, the target current determination section 2515 identifies the current value Ioutt3 smaller than the current value Ioutt2 as the discharge target current value. Next, by using current value information indicating the identified discharge target current value, the target current determination section 2515 updates discharge target current value information stored in the discharge target current value storage section 531 (step S203). Subsequently, the operation in step S201 is repeated.

As described above, with the battery module according to the present preferred embodiment, when the charge-discharge circuit 13 is caused to operate in the charge mode, the unit controller 51 changes the target current value of output current of the discharge circuit depending on SOC of the battery 41. With this configuration, when SOC of the battery 41 decreases, the current flowing from the discharge circuit 14 to the load 31 can be reduced, and as a result, it is possible to reduce or prevent unnecessary discharge of the battery 41.

### Third Preferred Embodiment

A power system according to the present preferred embodiment differs from the first preferred embodiment in that a unit controller sets a target current value of output current of a discharge circuit based on records of the current value of the current supplied from a power supply unit to a load for a preset determination period including a present time point.

The configuration of the power system according to the present preferred embodiment is almost the same as the configuration of the power system according to the first preferred embodiment, but only the functional configuration of the unit controller is different. In the description of the present preferred embodiment, the same configurations as the first preferred embodiment are described with the same reference characters as in FIGS. 1 and 2.

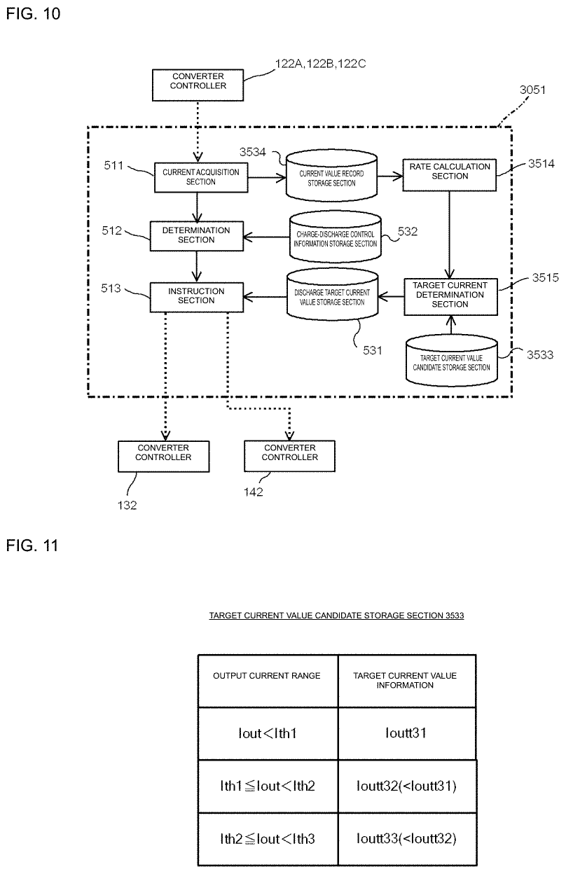

As illustrated in FIG. 10, a unit controller 3051 has the same hardware configuration as the unit controller 51 described in the first preferred embodiment and functions as the current acquisition section 511, the determination section 512, the instruction section 513, a rate calculation section 3514, and a target current determination section 3515. In FIG. 10, the same configurations as the first preferred embodiment are denoted by the same reference characters as in FIG. 3. The memory includes the discharge target current value storage section 531, the charge-discharge control information storage section 532, a target current value candidate storage section 3533, and a current value record storage section 3534. The target current value candidate storage section 3533 stores, for example, as indicated in FIG. 11, target current value information indicating a current value as a candidate of the discharge target current value of the discharge circuit 14 in association with information indicating an output current range of the converter sections 12A, 12B, and 12C of the highest rate of occurrence. In the example indicated in FIG. 11, when the output current range of the converter sections 12A, 12B, and 12C is smaller than the current threshold Ith1, the discharge target current value of the discharge circuit 14 is set to a current value Ioutt31. When the output current range of the converter sections 12A, 12B, and 12C is equal to or greater than the current threshold Ith1 and smaller than the current threshold Ith2, the discharge target current value of the discharge circuit 14 is set to a current value Ioutt32 smaller than the current value Ioutt31. When the output current range of the converter sections 12A, 12B, and 12C is equal to or greater than the current threshold Ith2 and smaller than the current threshold Ith3, the discharge target current value of the discharge circuit 14 is set to a current value Iott33 smaller than the current value Ioutt32. In other words, the greater the output current range of the converter sections 12A, 12B, and 12C of the highest rate of occurrence is, the smaller value the discharge target current value of the discharge circuit 14 is set to.

Referring back to FIG. 10, the current value record storage section 3534 stores information indicating a record of the current value of output current of the converter sections 12A, 12B, and 12C consecutively for a preset determination period including a present time point in chronological order. The determination period may be set to, for example, about 1 min.

The current acquisition section 511 acquires from the converter controllers 122A, 122B, and 122C current value information indicating a current value of output current of the AC-DC converters 121A, 121B, and 121C, and the current acquisition section 3511 responsively informs the determination section 512 of the acquired current value information and stores the acquired current value information in the current value record storage section 3534 in chronological order. The rate calculation section 3514 refers to the information stored in the current value record storage section 3534 and the information stored in the target current value candidate storage section 3533 and accordingly calculates the rate of occurrence of each output current range stored in the target current value candidate storage section 3533 in the determination period. The rate calculation section 3514 informs the target current determination section 3515 of occurrence rate information indicating the calculated rate of occurrence of each output current range. In accordance with the occurrence rate information provided by the rate calculation section 3514, the target current determination section 3515 identifies an output current range of the highest rate of occurrence. The target current determination section 3515 refers to the information stored in the target current value candidate storage section 3533 and identifies a target current value associated with the identified output current range of the highest rate of occurrence as the discharge target current value. By using target current value information indicating the identified discharge target current value, the target current determination section 3515 updates discharge target current value information stored in the discharge target current value storage section 531.

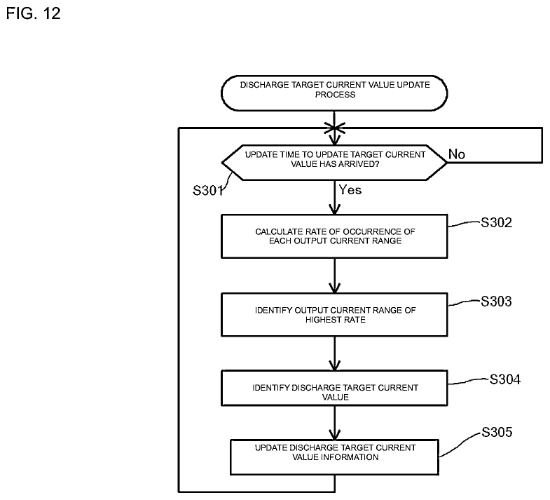

The following describes a discharge target current value update process performed by the unit controller according to the present preferred embodiment with reference to FIG. 12. Firstly, the rate calculation section 3514 determines whether a preset update time to update the discharge target current value has arrived (step S301). While the rate calculation section 3514 determines that the update time to update the discharge target current value has not arrived (No in step S301), the rate calculation section 3514 repeats the operation in step S301. By contrast, it is assumed that the rate calculation section 3514 determines the update time to update the discharge target current value has arrived (Yes in step S301). In this case, the rate calculation section 3514 refers to the information stored in the current value record storage section 3534 and the information stored in the target current value candidate storage section 3533 and accordingly calculates the rate of occurrence of each output current range stored in the target current value candidate storage section 3533 in the determination period (step S302). Next, in accordance with the occurrence rate information provided by the rate calculation section 3514, the target current determination section 3515 identifies an output current range of the highest rate of occurrence (step S303). The target current determination section 3515 subsequently refers to the information stored in the target current value candidate storage section 3533 and identifies a target current value associated with the identified output current range of the highest rate of occurrence as the discharge target current value (step S304). By using target current value information indicating the identified discharge target current value, the target current determination section 3515 updates discharge target current value information stored in the discharge target current value storage section 531 (step S305). Subsequently, the operation in step S301 is repeated.

As described above, with the battery module according to the present preferred embodiment, the unit controller 3051 sets the discharge target current value of the discharge circuit 14 based on records of the current value of output current of the converter sections 12A, 12B, and 12C for the determination period including a present time point. With this configuration, the discharge target current value of the discharge circuit 14 can be set to an appropriate current value based on records regarding the condition of the load 31 for the determination period, and as a result, it is possible to reduce or prevent a change in the voltage outputted to the load 31.

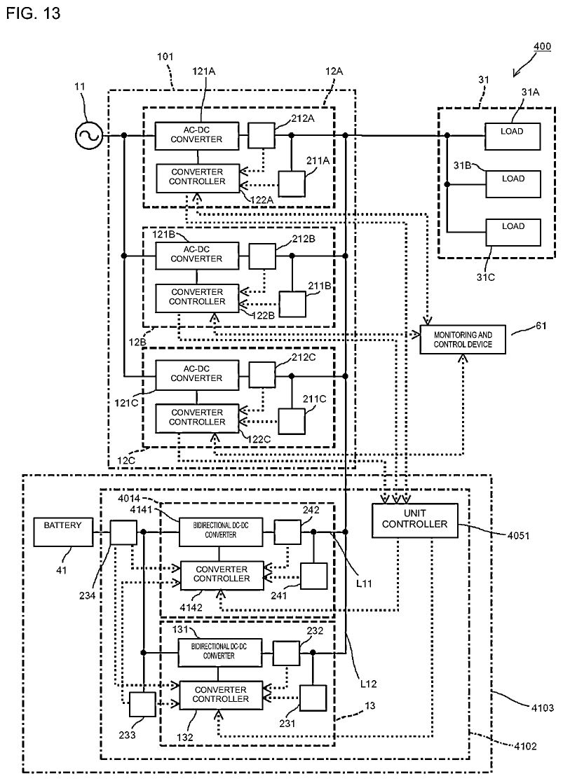

Although the above has described the preferred embodiments of the present invention, the present invention is not limited to the configurations of the preferred embodiments. For example, as a power system 400 illustrated in FIG. 13, a charge-discharge unit 4102 of a battery module 4103 may include two charge-discharge circuits 13 and 4014, the battery 41, the current detector 234, the voltage detector 233, and a unit controller 4051. In FIG. 13, the same configurations as the first preferred embodiment are denoted by the same reference characters as in FIG. 1. The charge-discharge circuit 4014 operates in an operation mode of the charge mode or the discharge mode. In the charge mode, the charge-discharge circuit 4014 receives electric power supplied from the power supply unit 101 and charges the battery 41. In the discharge mode, the charge-discharge circuit 4014 discharges electricity accumulated in the battery 41 to the load 31. The charge-discharge circuit 4014 includes a bidirectional DC-DC converter 4141, a converter controller 4142 to control the operation of the bidirectional DC-DC converter 4141, the current detector 242, and the voltage detector 241.

The unit controller 4051 can control the two charge-discharge circuits 13 and 4014 in a first mode to a fourth mode. Under the control of a first mode, the current detector 242 detects a value greater than zero as the current flowing in the direction from the bidirectional DC-DC converter 4141 to the wire L11, and the current detector 232 detects a value greater than zero as the current flowing in the direction from the wire L12 to the bidirectional DC-DC converter 131. In this practical example, in the condition in which Iout<Ith3, the control of the first mode is provided.

Under the control of a second mode, the current detector 242 detects a value greater than zero as the current flowing in the direction from the bidirectional DC-DC converter 4141 to the wire L11, and the charge termination operation is performed to terminate charging of the bidirectional DC-DC converter 131. In this modification, in the condition in which Iout≥Ith3, the control of the second mode is provided.

Under the control of a third mode, the current detector 232 detects a value greater than zero as the current flowing in the direction from the bidirectional DC-DC converter 131 to the wire L12, and the current detector 242 detects a value greater than zero as the current flowing in the direction from the wire L11 to the bidirectional DC-DC converter 4141. In this practical example, in the condition in which Iout<Ith3, the control of the third mode is provided.

Under the control of a fourth mode, the current detector 232 detects a value greater than zero as the current flowing in the direction from the bidirectional DC-DC converter 131 to the wire L12, and the charge termination operation is performed to terminate charging of the bidirectional DC-DC converter 4141. In this practical example, in the condition in which Iout Ith3, the control of the fourth mode is provided.

The unit controller 4051 may set modes for control with respect to a given period. Whenever a preset time for mode change arrives, the unit controller 4051 may change the modes for control. For example, when the given period is determined to be one month, control is provided in the first and second modes for the first one month, whereas control in the third and fourth modes is not provided. For the subsequent one month, control is provided in the third and fourth modes, whereas control in the first and second modes are not provided. In such a manner, the period for control is changed every one month.

This configuration can shorten the period for which the capacitor coupled on the load 31 side of the bidirectional DC-DC converters 131 and 4141 operating in only the discharge mode in the two charge-discharge circuits 13 and 4014 repeats charging and discharging. As a result, when the capacitor is an electrolytic capacitor, it is possible to reduce or prevent deterioration of the capacitor due to repeat charging and discharging, thus extending the life of the bidirectional DC-DC converters 131 and 4141.

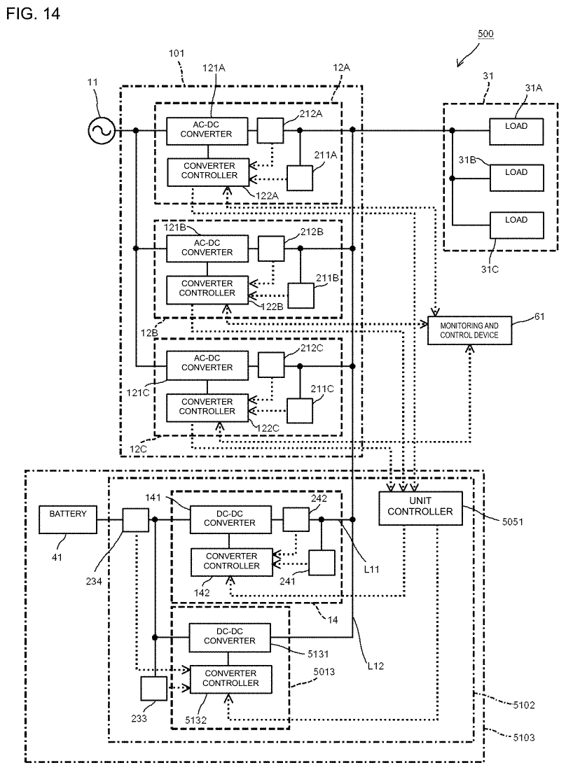

In the first preferred embodiment, the description is about the example in which the charge-discharge unit 102 includes the charge-discharge circuit 13, the discharge circuit 14, the battery 41, the current detector 234, the voltage detector 233, and the unit controller 51. However, this is not to be interpreted as limiting. For example, as a power system 500 illustrated in FIG. 14, a charge-discharge unit 5102 of a battery module 5103 may include the discharge circuit 14, a charge circuit 5013, the battery 41, the current detector 234, the voltage detector 233, and the unit controller 4051. In FIG. 14, the same configurations as the first preferred embodiment are denoted by the same reference characters as in FIG. 1. The charge circuit 5013 receives electric power supplied by the power supply unit 101 and charges the battery 41. The charge circuit 5013 includes a DC-DC converter 5131 and a converter controller 5132 to control the operation of the DC-DC converter 5131.

With this configuration, the configuration of the charge-discharge unit 5102 can be simplified.

In the first preferred embodiment, the description is about the example in which, when the charge-discharge circuit 13 is caused to operate in the charge mode, the unit controller 51 maintains a specific target value of output current of the discharge circuit 14 and changes the output current of the charge-discharge circuit 13 depending on the condition of the load 31. However, this is not to be interpreted as limiting. For example, when the charge-discharge circuit 13 is caused to operate in the charge mode, the unit controller 51 may control the discharge circuit 14 and the charge-discharge circuit 13 to change the output current of the discharge circuit 14 depending on the condition of the load 31 and to maintain the output current of the charge-discharge circuit 13 at a specific value.

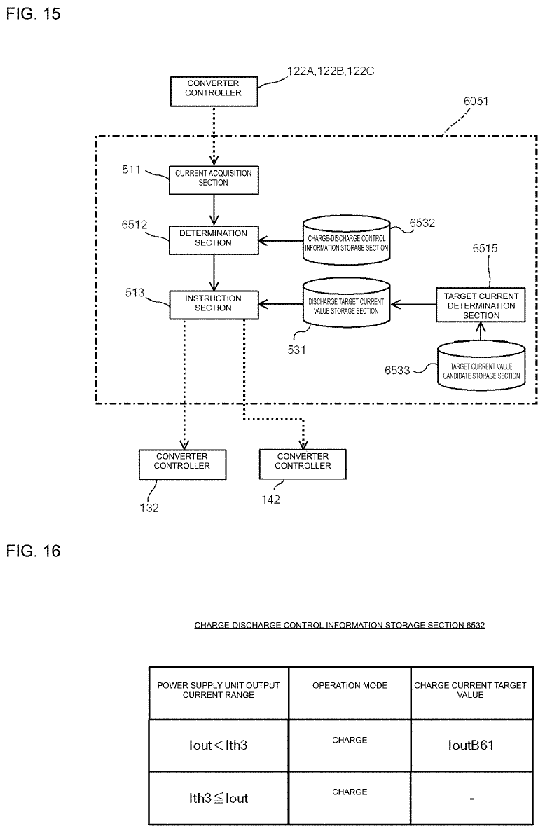

For example, as illustrated in FIG. 15, a unit controller 6051 according to this modification functions as the current acquisition section 511, a determination section 6512, the instruction section 513, and a target current determination section 6515. In FIG. 15, the same configurations as the first preferred embodiment are denoted by the same reference characters as in FIG. 3. The memory includes the discharge target current value storage section 531, a charge-discharge control information storage section 6532, and a target current value candidate storage section 6533. In the charge-discharge control information storage section 6532, for example, as indicated in FIG. 16, only one kind of charge target current value information corresponding to the charge mode is set. The target current value candidate storage section 6533 stores, for example, the same information as the target current value candidate storage section 3533 described in the third preferred embodiment. The target current determination section 6515 has the same function as the target current determination section 3515 described in the third preferred embodiment. The determination section 6512 refers to the information stored in the charge-discharge control information storage section 6532 and determines the operation mode of the charge-discharge circuit 13, based on the current value of output current indicated by the information provided by the current acquisition section 511. Here, when the current value Iout, which is supplied from the power supply unit 101 to the load 31, is equal to or greater than the upper limit current value Ith3, the determination section 6512 selects the discharge mode. When the current value Iout is smaller than the upper limit current value Ith3, the determination section 6512 selects the charge mode. When selecting the charge mode as the operation mode, the determination section 6512 selects the current value IoutB61 as the charge target current value irrespective of the current value Iout.

In the preferred embodiments, the descriptions are about the example in which the converter controller 142 controls the DC-DC converter 141 by PWM control in the discharge circuit 14, and the converter controller 132 controls the bidirectional DC-DC converter 131 by PWM control in the charge-discharge circuit 13. However, this is not to be interpreted as limiting. For example, in the discharge circuit 14, the converter controller 142 may control the DC-DC converter 141 by pulse frequency modulation (PFM) control. In the charge-discharge circuit 13, the converter controller 132 may control the bidirectional DC-DC converter 131 by PFM control.

The present invention may be embodied in other various preferred embodiments and modifications without departing from the broader spirit and scope of the present invention. The preferred embodiments are intended to be illustrative, but not limiting, of the scope of the present invention. This means that the scope of the present invention is indicated by the claims rather than the preferred embodiments described above. Various changes that come within the meaning and range of the claims or the meaning and range of equivalency of the claims are intended to be embraced in the present invention.

Preferred embodiments of the present invention and modifications or combinations thereof are applicable to a battery module used with a converter unit for a server, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A charge-discharge unit coupled between a load that is coupled to a power supply unit to convert electric power supplied from a power source and output a voltage and an electric accumulator that is coupled to the load to output a specific voltage, the charge-discharge unit being operable to control charging and discharging of the electric accumulator, the charge-discharge unit comprising:
a first power converter circuit and a second power converter circuit coupled in parallel between the load and the electric accumulator, the first power converter circuit being configured to output a current to the load, the second power converter circuit being configured to output a current to the electric accumulator; and
a unit controller coupled to the first power converter circuit and the second power converter circuit and configured or programmed to control the first power converter circuit and the second power converter circuit; wherein
an output of the first power converter circuit is electrically coupled to an input of the second power converter circuit;
an output of the second power converter circuit is electrically coupled to an input of the first power converter circuit; and
the unit controller is configured or programmed to control the first power converter circuit and the second power converter circuit in a first mode or a second mode;
in the first mode, the first power converter circuit and the second power converter circuit are controlled to each output a current greater than zero;
in the second mode, the first power converter circuit is controlled to output a current of a value greater than zero, and the second power converter circuit is caused to perform a charge termination operation of stopping the current outputted to the electric accumulator.

2. The charge-discharge unit according to claim 1, wherein the unit controller is configured or programmed to control the first power converter circuit and the second power converter circuit such that at least a portion of a current outputted from the first power converter circuit is inputted to the second power converter circuit, and at least a portion of a current outputted from the second power converter circuit is inputted to the first power converter circuit.

3. The charge-discharge unit according to claim 1, wherein the unit controller is configured or programmed to:
when a current supplied from the power supply unit to the load is smaller than a preset upper limit current value, control the first power converter circuit and the second power converter circuit in the first mode; and
when the current supplied from the power supply unit to the load is more than the preset upper limit current value, control the first power converter circuit and the second power converter circuit in the second mode.

4. The charge-discharge unit according to claim 1, wherein the unit controller is configured or programmed to control the first power converter circuit and the second power converter circuit in the first mode when electric power is supplied from the power source and in the second mode when no electric power is supplied from the power source.

5. The charge-discharge unit according to claim 1, wherein
the second power converter circuit includes a bidirectional DC-DC converter, and the second power converter circuit is configured to perform a charge operation of outputting a current to the electric accumulator and a discharge operation of outputting a current to the load; and
the unit controller is configured or programmed to, after the second power converter circuit performs the charge termination operation, control the first power converter circuit and the second power converter circuit in the second mode to perform the discharge operation.

6. The charge-discharge unit according to claim 1, wherein the unit controller is configured or programmed to, in the first mode, control a value of the current outputted by the first power converter circuit to the load and a value of the current outputted by the second power converter circuit to the electric accumulator, based on a record of a current value of a current supplied from the power supply unit to the load for a preset determination period including a present time point.

7. The charge-discharge unit according to claim 1, wherein
the first power converter circuit includes a non-isolated DC-DC converter including an inductor; and
the unit controller is configured or programmed to set a current value that enables a waveform of a current passed through the inductor and outputted from the first power converter circuit to the load to indicate a continuous mode.

8. The charge-discharge unit according to claim 1, wherein
the first power converter circuit and the second power converter circuit both include bidirectional DC-DC converters, and the first power converter circuit and the second power converter circuit are configured to perform a charge operation of outputting a current to the electric accumulator and a discharge operation of outputting a current to the load; and
the unit controller is configured or programmed to control the first power converter circuit and the second power converter circuit in a third mode or a fourth mode;
in the third mode, the first power converter circuit and the second power converter circuit are controlled such that the second power converter circuit outputs to the load a discharge power greater than zero, and the first power converter circuit outputs to the electric accumulator a current greater than zero;
in the fourth mode, the second power converter circuit is controlled to output to the load a current of a value greater than zero, and the first power converter circuit is caused to perform a charge termination operation of stopping the current outputted to the electric accumulator.

9. A battery module coupled to a power supply unit to convert electric power supplied from a power source and output a voltage, the battery module being operable to supply electric power to the load, the battery module comprising:
the charge-discharge unit according to claim 1; and
an electric accumulator coupled to the charge-discharge unit.

10. The battery module according to claim 9, wherein the unit controller is configured or programmed to control the first power converter circuit and the second power converter circuit such that at least a portion of a current outputted from the first power converter circuit is inputted to the second power converter circuit, and at least a portion of a current outputted from the second power converter circuit is inputted to the first power converter circuit.

11. The battery module according to claim 9, wherein the unit controller is configured or programmed to:
when a current supplied from the power supply unit to the load is smaller than a preset upper limit current value, control the first power converter circuit and the second power converter circuit in the first mode; and
when the current supplied from the power supply unit to the load is more than the preset upper limit current value, control the first power converter circuit and the second power converter circuit in the second mode.

12. The battery module according to claim 9, wherein the unit controller is configured or programmed to control the first power converter circuit and the second power converter circuit in the first mode when electric power is supplied from the power source and in the second mode when no electric power is supplied from the power source.

13. The battery module according to claim 9, wherein
the second power converter circuit includes a bidirectional DC-DC converter, and the second power converter circuit is configured to perform a charge operation of outputting a current to the electric accumulator and a discharge operation of outputting a current to the load; and
the unit controller is configured or programmed to, after the second power converter circuit performs the charge termination operation, control the first power converter circuit and the second power converter circuit in the second mode to perform the discharge operation.

14. The battery module according to claim 9, wherein the unit controller is configured or programmed to, in the first mode, control a value of the current outputted by the first power converter circuit to the load and a value of the current outputted by the second power converter circuit to the electric accumulator, based on a record of a current value of a current supplied from the power supply unit to the load for a preset determination period including a present time point.

15. The battery module according to claim 9, wherein
the first power converter circuit includes a non-isolated DC-DC converter including an inductor; and
the unit controller is configured or programmed to set a current value that enables a waveform of a current passed through the inductor and outputted from the first power converter circuit to the load to indicate a continuous mode.

16. The battery module according to claim 9, wherein
the first power converter circuit and the second power converter circuit both include bidirectional DC-DC converters, and the first power converter circuit and the second power converter circuit are configured to perform a charge operation of outputting a current to the electric accumulator and a discharge operation of outputting a current to the load; and
the unit controller is configured or programmed to control the first power converter circuit and the second power converter circuit in a third mode or a fourth mode;
in the third mode, the first power converter circuit and the second power converter circuit are controlled such that the second power converter circuit outputs to the load a discharge power greater than zero, and the first power converter circuit outputs to the electric accumulator a current greater than zero;
in the fourth mode, the second power converter circuit is controlled to output to the load a current of a value greater than zero, and the first power converter circuit is caused to perform a charge termination operation of stopping the current outputted to the electric accumulator.

17. A power system comprising:
a power supply unit to convert electric power supplied from a power source and output a voltage; and
the battery module according to claim 9, the battery module being coupled to the power supply unit.

18. The power system according to claim 17, wherein the unit controller is configured or programmed to control the first power converter circuit and the second power converter circuit such that at least a portion of a current outputted from the first power converter circuit is inputted to the second power converter circuit, and at least a portion of a current outputted from the second power converter circuit is inputted to the first power converter circuit.

19. The power system according to claim 17, wherein the unit controller is configured or programmed to:
when a current supplied from the power supply unit to the load is smaller than a preset upper limit current value, control the first power converter circuit and the second power converter circuit in the first mode; and
when the current supplied from the power supply unit to the load is more than the preset upper limit current value, control the first power converter circuit and the second power converter circuit in the second mode.

20. The power system according to claim 17, wherein the unit controller is configured or programmed to control the first power converter circuit and the second power converter circuit in the first mode when electric power is supplied from the power source and in the second mode when no electric power is supplied from the power source.
